(19) United States
(12) Patent Application Publication
(10) Pub. No.: US 2017/0297440 A1
(43) Pub. Date: Oct. 19, 2017

(54) DC/DC CONVERTER, BATTERY ENERGY MANAGEMENT SYSTEM AND HYBRID VEHICLE

(71) Applicant: Robert Bosch GmbH, Stuttgart (DE)

(72) Inventors: Jia Hu, Suzhou (CN); Binyan Xu, Suzhou (CN); Lei Zhang, Suzhou (CN); Lingling Li, Suzhou (CN)

(21) Appl. No.: 15/487,598

(22) Filed: Apr. 14, 2017

(30) Foreign Application Priority Data
Apr. 14, 2016 (CN) 201620310499.0

(51) Int. Cl. B60L 11/18; H02M 3/04

(52) U.S. Cl. CPC B60L 11/1811; H02M 3/04; B60L 11/1861; B60L 2210/10; B60Y 2200/92

(57) ABSTRACT

A DC/DC converter for a hybrid vehicle, a battery energy management system having the DC/DC converter and the corresponding hybrid vehicle. The DC/DC converter is configured to control an output voltage to be output to the low voltage grid in accordance with a battery status parameter information and/or a vehicle running status parameter information in the high voltage grid or the low voltage grid. This enables the state of charge of the low voltage battery pack to be in an appropriate range, and a space for storing the free energy is provided, which means more fuel saving. According to different vehicle running modes, the DC/DC converter can automatically control the output voltage to be increased or reduced.

### BACKGROUND OF THE INVENTION

The present invention generally relates to a hybrid vehicle, and more particularly to a DC/DC converter for the hybrid vehicle, a battery energy management system having the DC/DC converter and the corresponding hybrid vehicle.

With the increasing development of the hybrid vehicle, in the premise of dynamic property assurance, there are hotspot issues to be resolved in the industry that how to ensure a minimum fuel consumption and discharge and keep the state of charge (SOC) in a better range. Typically, the storage battery used in the hybrid vehicle is lead battery, NI-MH battery or lithium ion battery. Taking the lead battery as an example, the lead battery of 12V is the power supply for a low voltage system of the whole vehicle, which converts a high voltage power supply of a high voltage battery pack into a low voltage power supply through the DC/DC converter, and the lead battery is charged by controlling the on-off of the DC/DC converter.

In the current hybrid power system, it is not recognized to control an output voltage of a low voltage side (12V or 14V) of the DC/DC converter. Thus, the DC/DC converter is typically used as a traditional electric generator. When the DC/DC converter is in a charged state, the lead battery will always be charged no matter whether it is fully charged or not, thus the lead battery will be overcharged, and therefore its working life is largely reduced. Moreover, when the high voltage battery pack is fully charged, there is no space for storing an additional energy such as a free energy generated upon braking or sliding the vehicle, which means a waste of energy and high fuel loss.

### SUMMARY OF THE INVENTION

The objective of the present invention is to improve the control of the output object voltage of the DC/DC converter of the current hybrid vehicle so as to keep the state of charge of the storage battery and specifically the low voltage battery at an appropriate level, such that the sufficient power can be provided when the vehicle is started or speeded up and the energy can be recovered when the vehicle is braked or slowed down, thereby increasing the working life and security of the battery and reducing the fuel loss.

To this end, according to one aspect, the present invention provides a DC/DC converter for a hybrid vehicle having a high voltage grid and a low voltage grid, wherein the DC/DC converter is configured to control an output voltage to be output to the low voltage grid in accordance with a battery status parameter information and/or a vehicle running status parameter information in the high voltage grid or the low voltage grid.

In some preferred embodiments, the DC/DC converter is in communication with a monitoring unit for collecting the battery status parameter information and/or the vehicle running status parameter information and a controlling unit for controlling the output voltage by a CAN bus.

In the case of collecting the battery status parameter information to control the output voltage, according to one embodiment, the DC/DC converter is configured to reduce the output voltage when a low voltage battery pack of the low voltage grid is in a high state of charge, thereby stopping charging the low voltage battery pack to save energy.

According to another embodiment, the DC/DC converter is configured to increase the output voltage when the state of charge of a low voltage battery pack of the low voltage grid is less than a predetermined threshold or a high voltage battery pack of the high voltage grid is in a high state of charge, thereby charging the low voltage battery pack. At this moment, the free energy generated during the vehicle running status (such as braking or sliding) is recovered and stored in the low voltage battery pack.

In some preferred embodiments, the high voltage grid comprises a motor, the battery status parameter information of the high voltage grid is obtained by the motor and a battery management system (BMS), and the battery status parameter information of the low voltage grid is obtained by an electronic battery sensor (EBS). With such information, the DC/DC converter can control the object output voltage for the low voltage grid. In this way, the state of charge of the low voltage battery pack is always in an appropriate range to store more free energy.

In the case of collecting the vehicle running status parameter information to control the output voltage, according to one embodiment, the DC/DC converter is configured to reduce the output voltage when the vehicle is in a started or speeded-up process, so as to facilitate the engine to provide more energy to speed up.

According to another embodiment, the DC/DC converter is configured to increase the output voltage when the vehicle is in a slowed-down or braked process, in order to save more free energy.

According to another aspect, the present invention provides a battery energy management system comprising a high voltage grid and a low voltage grid connected through the above-described DC/DC converter.

According to yet another aspect, the present invention provides a hybrid vehicle comprising the above-described battery energy management system.

The main advantage of the present invention is that the state of charge of the low voltage battery pack is always kept in an appropriate range, and a space for storing the free energy is provided, which means more fuel saving. According to different vehicle running modes, the DC/DC converter can automatically control the output voltage to be increased or reduced. Additionally, in the battery energy management system of the present invention, the traditional electric generator is replaced by the motor, thus it can generate high voltage energy in the electric generator mode. Meanwhile, the motor can also be used as electromotor to increase the energy of the vehicle engine or directly start the engine.

### BRIEF DESCRIPTION OF THE DRAWINGS

Other features and advantages will be better understood with reference to the following description of the illustrative embodiments taken in conjunction with the accompanying drawings:

FIG. 1 is an illustrative view of a battery energy management system for a hybrid vehicle according to the present invention; and

FIG. 2 is a view illustrating that the hybrid vehicle having the battery energy management system according to the present invention automatically adjusts the output voltage of the DC/DC converter in the running process.

### DETAILED DESCRIPTION

The following description will discuss the implementation and employment of the embodiments; however, it should be noted that the discussed embodiments are intended to illustrate the specific forms of the implementation and employment of the embodiments, rather than to limit the scope of the present invention.

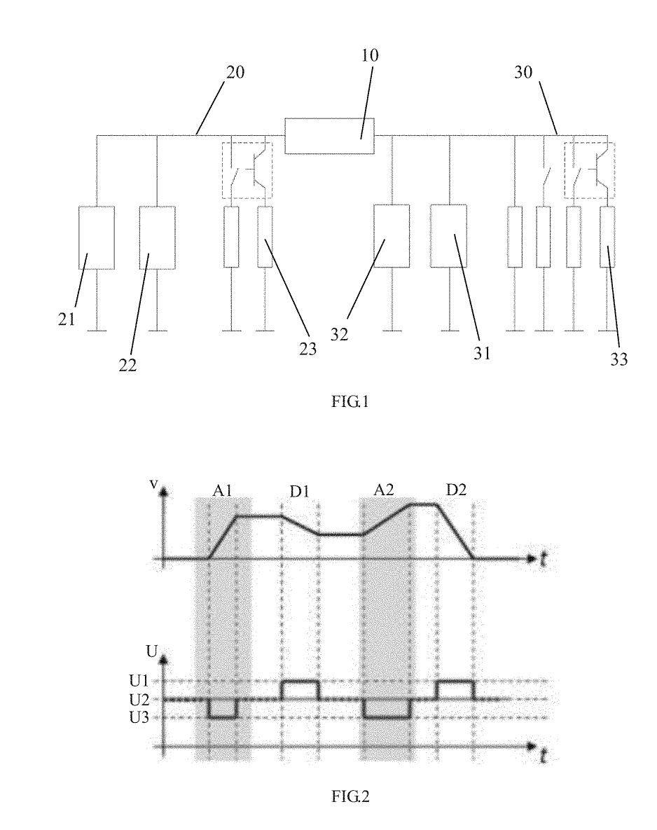

Firstly, FIG. 1 illustrates a battery energy management system for a hybrid vehicle having a DC/DC converter according to the present invention. The battery energy management system comprises a high voltage grid 20 and a low voltage grid 30 connected through a DC/DC converter 10. The high voltage grid 20 comprises a motor 21, a high voltage battery pack 22 and a high voltage load component 23. The low voltage grid 30 comprises a starter 31, a low voltage battery pack 32 and a low voltage load component 33. According to the present invention, the DC/DC converter 10 is configured to control an output voltage to be output to the low voltage grid 30 in accordance with a battery status parameter information and/or a vehicle running status parameter information in the high voltage grid 20 or the low voltage grid 30. Thus, the battery energy management system advantageously improves the level of the state of charge of the low voltage battery pack in the vehicle-mounted low voltage grid having a voltage of 12V, thereby saving energy and enhancing the fuel economy, and increasing the working life of the low voltage battery pack simultaneously.

For simplicity, FIG. 1 only shows the main portions of the battery energy management system. It should be appreciated that the battery energy management system necessarily comprises associated monitoring unit and controlling unit. For example, the high voltage grid 20 is 48V vehicle-mounted high voltage grid, and the motor 21 advantageously replaces the electric generator in the traditional hybrid vehicle. The motor 21 can be driven to operate by an internal combustion engine, and generate electric energy according to the rotating motion of the internal combustion engine in the electric generator mode and feed into the high voltage grid 20 so as to operate a plurality of high voltage load components 23. Meanwhile, the motor 21 can be used as electromotor to increase the energy of the engine of the vehicle or directly start the engine. The starter 31 for starting the internal combustion engine and the low voltage battery pack 32 are arranged in the low voltage grid 30 at the output side of the DC/DC converter 10, and a direct voltage (for example, 12V to 48V) at the input side is converted to an output voltage (for example, 12V to 14V) at the output side through the DC/DC converter 10 so as to operate a plurality of low voltage load components 33.

Preferably, the DC/DC converter 10 is in communication with a monitoring unit for collecting a battery status parameter information and/or a vehicle running status parameter information and a controlling unit for controlling the output voltage by a CAN bus so as to implement the transmission among the associated electrical grid status information, the vehicle running status information and controlling parameters. The battery status parameter information of the high voltage battery pack 22 of the high voltage grid 20 is obtained by the motor 21 and a battery management system BMS (not shown) and the battery status parameter information of the low voltage battery pack 32 of the low voltage grid 30 is obtained by an electronic battery sensor EBS (not shown). For example, the battery management system BMS is used to monitor and manage the battery status parameters including the temperature, voltage, current and the state of charge SOC of the battery pack, etc. Based on the collected battery status parameter information, the DC/DC converter 10 can control the output voltage at the output side thereof.

In the case of collecting the battery status parameter information to control the output voltage, when the low voltage battery pack 32 is fully charged and in a high state of charge, the DC/DC converter 10 reduces the output voltage, thereby stopping charging the low voltage battery pack 32. When the low voltage battery pack 32 is not fully charged and the state of charge is less than a predetermined threshold, or the high voltage battery pack 22 is in a high state of charge, the motor 21 is changed to a electric generator mode, and the output voltage is increased by the DC/DC converter 10 so as to charge the low voltage battery pack 32. Moreover, in this case, the battery pack can recover the energy generated upon braking, downgrading or idling the vehicle, thereby largely increasing the efficiency of energy recovery and reducing the fuel loss.

In the case of collecting the vehicle running status parameter information to control the output voltage, according to the present invention, the DC/DC converter is configured to automatically control the output voltage to increase or reduce according to different vehicle running modes. With reference to FIG. 2, in the vehicle running process, depending on different speeds v, there are speeding-up processes A1 and A2, slowing-down processes D1 and D2, and constant speed process therebetween. In the constant speed process, the output voltage of the DC/DC converter is kept at a general level U2; in the speeding-up processes A1 and A2, for example, when the vehicle is started or speeded up, the output voltage of the DC/DC converter is reduced to a low level U3; and in the slowing-down processes D1 and D2, for example, when the vehicle is slowed down or braked, the output voltage of the DC/DC converter is increased to a high level U1.

In order to better understand the present invention, the above description explains the case of collecting the battery status parameter information or the vehicle running status parameter information; however, it should be noted that two kinds of status parameter information are not absolutely independent. In the actual using process of the hybrid vehicle, the battery energy management system according to the present invention can communicate through the CAN bus so as to implement the collecting of the associated status parameter information and the transmitting of the associated control instruction. The DC/DC converter can accordingly reduce or increase the output voltage at the side of the low voltage grid according to these information so that the state of charge of the low voltage battery pack is always in an appropriate range, thus the battery may be kept in a good working state, thereby preventing from being overcharged or overdischarged, extending the working life and reducing the cost. Meanwhile, more free energy can be stored, and the dynamic property and the economic efficiency of the hybrid vehicle can be ensured to a large degree.

The above description discloses the technical contents and technical features of the present invention; however, it should be appreciated that within the creative concept of the present invention, the person skilled in the art can make various modifications and improvements, which will be regarded within the scope of this invention. The above description of the embodiment is illustrative rather than restrictive. The scope of this invention is defined by the attached claims.

What is claimed is:

1. A DC/DC converter for a hybrid vehicle having a high voltage grid and a low voltage grid, wherein the DC/DC converter is configured to control an output voltage to be output to the low voltage grid in accordance with battery status parameter information, vehicle running status parameter information, or both battery status parameter information and vehicle running status parameter information in the high voltage grid or the low voltage grid.

2. The DC/DC converter according to claim 1, wherein the DC/DC converter is in communication with a monitoring unit for collecting the battery status parameter information and/or the vehicle running status parameter information and a controlling unit for controlling the output voltage by a CAN bus.

3. The DC/DC converter according to claim 1, wherein the DC/DC converter is configured to reduce the output voltage when a low voltage battery pack of the low voltage grid is in a high state of charge.

4. The DC/DC converter according to claim 1, wherein the DC/DC converter is configured to increase the output voltage when the state of charge of a low voltage battery pack of the low voltage grid is less than a predetermined threshold or a high voltage battery pack of the high voltage grid is in a high state of charge.

5. The DC/DC converter according to claim 3, wherein the high voltage grid comprises a motor, the battery status parameter information of the high voltage grid is obtained by the motor and a battery management system, and the battery status parameter information of the low voltage grid is obtained by an electronic battery sensor.

6. The DC/DC converter according to claim 1, wherein the DC/DC converter is configured to reduce the output voltage when the vehicle is in a started or speeded-up process.

7. The DC/DC converter according to claim 1, wherein the DC/DC converter is configured to increase the output voltage when the vehicle is in a slowed-down or braked process.

8. A battery energy management system comprising a high voltage grid and a low voltage grid connected through the DC/DC converter according to claim 1.

9. A hybrid vehicle comprising a battery energy management system according to claim 8.

10. A DC/DC converter for a hybrid vehicle having a high voltage grid and a low voltage grid, wherein the DC/DC converter is configured to control an output voltage to be output to the low voltage grid in accordance with battery status parameter information.

11. The DC/DC converter according to claim 10, wherein the DC/DC converter is in communication with a monitoring unit for collecting the battery status parameter information and a controlling unit for controlling the output voltage by a CAN bus.

12. The DC/DC converter according to claim 10, wherein the DC/DC converter is configured to reduce the output voltage when a low voltage battery pack of the low voltage grid is in a high state of charge.

13. The DC/DC converter according to claim 10, wherein the DC/DC converter is configured to increase the output voltage when the state of charge of a low voltage battery pack of the low voltage grid is less than a predetermined threshold or a high voltage battery pack of the high voltage grid is in a high state of charge.

14. The DC/DC converter according to claim 12, wherein the high voltage grid comprises a motor, the battery status parameter information of the high voltage grid is obtained by the motor and a battery management system, and the battery status parameter information of the low voltage grid is obtained by an electronic battery sensor.

15. The DC/DC converter according to claim 10, wherein the DC/DC converter is configured to reduce the output voltage when the vehicle is in a started or speeded-up process.

16. The DC/DC converter according to claim 10, wherein the DC/DC converter is configured to increase the output voltage when the vehicle is in a slowed-down or braked process.

17. A DC/DC converter for a hybrid vehicle having a high voltage grid and a low voltage grid, wherein the DC/DC converter is configured to control an output voltage to be output to the low voltage grid in accordance with vehicle running status parameter information.

18. The DC/DC converter according to claim 17, wherein the DC/DC converter is in communication with a monitoring unit for collecting the vehicle running status parameter information and a controlling unit for controlling the output voltage by a CAN bus.

19. The DC/DC converter according to claim 17, wherein the DC/DC converter is configured to reduce the output voltage when a low voltage battery pack of the low voltage grid is in a high state of charge.

20. The DC/DC converter according to claim 17, wherein the DC/DC converter is configured to increase the output voltage when the state of charge of a low voltage battery pack of the low voltage grid is less than a predetermined threshold or a high voltage battery pack of the high voltage grid is in a high state of charge.

21. The DC/DC converter according to claim 17, wherein the DC/DC converter is configured to reduce the output voltage when the vehicle is in a started or speeded-up process.

22. The DC/DC converter according to claim 17, wherein the DC/DC converter is configured to increase the output voltage when the vehicle is in a slowed-down or braked process.

23. The DC/DC converter according to claim 17, wherein the DC/DC converter is also configured to control the output voltage to be output to the low voltage grid in accordance with battery status parameter information.
